(19) United States
(12) Patent Application Publication
(10) Pub. No.: US 2007/0211458 A1
(43) Pub. Date: Sep. 13, 2007

(54) Light module, light multiple module and use of a light module or light multiple module for illumination or backlighting

(75) Inventors: Ralph Peter Bertram, Regensburg (DE); Katrin Schroll, Matzing (DE); Harald Stoyan, Regensburg (DE); Robert Kraus, Regensburg (DE)

Correspondence Address: COHEN PONTANI LIEBERMAN & PAVANE LLP, Suite 1210, 551 Fifth Avenue, New York, NY, 10176, US

(73) Assignee: Patent-Treuhand-Gesellschaft fur elektrische Gluhlampen mbH, Munchen (DE)

(21) Appl. No.: 11/700,445

(22) Filed: Jan. 31, 2007

(30) Foreign Application Priority Data
Feb. 1, 2006 (DE) 10 2006 004 581.5

(51) Int. Cl. B60Q 1/26

(52) U.S. Cl. 362/227

(57) ABSTRACT

A light module (1) comprising a plurality of radiation-emitting semiconductor components (2), each of which is assigned an emission angle (2φ), comprising at least one component having an optical element (9) that enlarges the emission angle (2φ), and comprising a common optical device for focusing the radiation. The radiation is intermixed by means of the optical element (9). Also disclosed is a light multiple module (16), which has at least two light modules (1).

### RELATED APPLICATIONS

The patent application claims the priority of German Patent Application 10 2006 004 581.5 filed Feb. 1, 2006, the disclosure content of which is hereby incorporated by reference.

### FIELD OF THE INVENTION

The invention relates both to a light module and to a light multiple module having at least two light modules. The invention furthermore relates to a use of the light module or of the light multiple module.

### BACKGROUND OF THE INVENTION

U.S. Pat. No. 6,299,337 discloses a flexible LED multiple module suitable for incorporation into luminaire housings, in particular for motor vehicles. The LED multiple module has a plurality of LEDs integrated into a circuit. In accordance with one embodiment, optical elements for beam guiding and/or focusing are placed in front of the light exit area of the LEDs. Furthermore, the LED multiple module can be inserted into a luminaire housing with a transparent front face containing a multiplicity of lenses for focusing the light emitted by the LEDs.

### SUMMARY OF THE INVENTION

It is one object of the present invention to provide a light module whose emission properties can be realized or set in a simple manner.

It is another object of the present invention to provide a light multiple module whose emission properties can be realized or set in a simple manner.

These and other objects are attained in accordance with one aspect of the present invention directed to a light module comprising a plurality of radiation-emitting semiconductor components, each of which is assigned an emission angle, wherein at least one of the components has an optical element that enlarges the emission angle. Furthermore the light module comprises a common optical device for focusing the radiation, wherein the radiation is intermixed by means of the optical element.

It is advantageous that, by means of an intermixing of the radiation, particularly in the case of large areas to be illuminated, it is possible to prevent the occurrence of distinctly visible color differences on the areas to be illuminated on account of manufacturing tolerances with regard to the color location of the individual components.

In accordance with one preferred embodiment, the radiation is intermixed in such a way that a uniform color location is assigned to a predetermined area illuminated by means of the light module. As a result, areas can advantageously be chromatically homogeneously illuminated.

In accordance with a further embodiment, the radiation is focused by means of the optical device in such a way that the predetermined area is illuminated by means of the light module with a uniform luminous intensity. This has the advantage that areas can be illuminated with a uniform luminous intensity.

Overall, the homogeneity of the color location and/or of the luminous intensity contributes to the light module being suitable for qualitatively demanding illumination or backlighting purposes.

In one advantageous development, each component has an optical element for enlarging the emission angle. As a result, the radiation emitted by the components can be intermixed at a comparatively small distance from the plane, where the components are arranged.

An optical element that enlarges the emission angle may have a radiation exit area comprising a concavely curved partial region and a convexly curved partial region, which at least partly surrounds the concavely curved partial region at a distance from an optical axis, wherein the optical axis runs through the concavely curved partial region.

Such a shaping of the radiation exit area enables a radiation power that is coupled out from the optical element at a comparatively large angle with respect to the optical axis to be increased compared with the coupled-out radiation power of the component without said optical element. In particular the convexly curved partial region may contribute to this, said convexly curved partial region increasing the radiation component that is coupled out from the optical element at large angles with respect to the optical axis. The component comprising an optical element of this type is accordingly particularly suitable for the homogeneous illumination of a comparatively large, in particular planar, area even in area regions offset laterally with respect to the optical axis.

The light module having components of this type is preferably suitable for general lighting and for backlighting, for example of a display device, for instance of an LCD (liquid crystal display).

The components are preferably arranged on a carrier. Said carrier serves, on the one hand, for fixing the components. On the other hand, the carrier may have, for the interconnection of the components, conductor track structures and electrical connections which are connected to a power supply. Furthermore, the carrier, which is embodied in particular as a metal core substrate, for instance in the form of a metal core circuit board, may contain a heat sink or material having comparatively good thermal conductivity. As a result, particularly in the case of high-power applications, a comparatively stable operation of the light module with an advantageous degradation behavior can preferably be achieved.

The optical device provided for focusing the radiation generated by the components may be a reflective element. By means of the optical device, it is possible to advantageously influence a main emission direction of the light module, on the one hand, and an emission angle of the light module, on the other hand.

Furthermore, any optical unit which enables beam shaping and/or beam control is suitable as optical device in the context of the invention. The optical device may also be a refractive or diffractive element or a combination of said elements.

If the optical device is a reflective element, then this may be formed by means of reflective side walls connected to the carrier. In accordance with one preferred embodiment, the carrier is a carrier plate with a planar main area to which are fitted two reflective side walls set up in wing-like fashion.

Proceeding from the main area of, the carrier, the side walls, viewed in cross-section, form an angle of inclination of 0°<α≦90° with the main area of the carrier. The angle α of inclination is adapted to the emission properties of the components and the desired emission characteristic of the light module. In the present case, the angle of inclination is preferably α=65°.

Both a V cross-sectional form and a U cross-sectional form are suitable for an arrangement comprising the carrier and the optical device. Furthermore, a non-plane shape of the side walls is suitable, which then have for example a curved, for instance a parabolic, cross-sectional form. In particular, a well form or channel form is suitable for the arrangement comprising the carrier and the optical device.

Of the components which the light module comprises, in accordance with one preferred configuration, at least two components generate radiation of different colors. This has the advantage that the light module can emit mixed-colored light, in particular white light. Any desired color locations can be set by means of a suitable combination or driving of varicolored components.

By way of example, the light module may have a first component emitting red light, a second component emitting green light and a third component emitting blue light.

In accordance with a further preferred configuration, a first component generates red light, a second component generates green light, a third component generates blue light and a fourth component generates white light. An improved color rendering index can be obtained by means of such a combination of varicolored components. Furthermore, the illuminant of the component emitting white light can be shifted as desired by means of an admixture of red, green or blue light.

In particular, the light module may be assigned different color locations by means of a change in the current supply. This is because the use of components which emit red, green and blue light and whose light is correspondingly mixed proportionately makes it possible, in principle, to achieve any color location in the color space.

Furthermore, the light module may have at least two components which generate radiation of the same color. This advantageously enables the radiation power of the light module to be increased.

The components that generate radiation of the same color are preferably connected up in series. This advantageously facilitates a color location setting, in particular an illuminant setting, of the light module since the components can be driven jointly for setting purposes. The light module has a microprocessor, for example, which controls or else regulates the power supply to different groups of components connected up in series. The color location required for the desired color location or illuminant is stored for each group in said microprocessor. The current supply is correspondingly adapted to the color location.

In accordance with one preferred embodiment, the components are arranged in row-like fashion. The light module then has the form of a light string. Further light modules of this type can advantageously be strung together in order to lengthen the light string. Furthermore, it is possible to arrange a plurality of light modules of this type areally alongside one another.

Components which are surface-mountable are suitable for the light module. Components of this type permit simple mounting thereof and therefore contribute to reducing the production outlay for the light module.

Typically, each component has a housing body in which a radiation-emitting semiconductor body is arranged. In particular, the semiconductor body is a light-emitting diode.

A component that is suitable in the context of the invention is disclosed in published US application no. 2004/0075100, the content of which is hereby incorporated by reference.

The light module can be produced by a metal layer containing copper, for example, being vapor-deposited on a plastic carrier and subsequently being structured, for example by means of laser action, into conductor tracks and electrical connection pads for the components. Reflective side walls are fitted to the main area of the carrier. The components are arranged on the main area of the carrier between the side walls.

In accordance with one preferred configuration, a light multiple module has at least two light modules which may be formed according to the embodiments already mentioned. The radiation intensity of the light multiple module can advantageously be increased relative to the light module by means of the number of light modules.

As already mentioned, the light modules may be arranged in row-like fashion or in matrix-like fashion.

In accordance with a further preferred configuration, the light modules are connected up in parallel. This advantageously enables the color locations of the light modules to be shifted simultaneously.

Particularly preferably, a predetermined area illuminated by means of the light modules is assigned in each case the same color location.

In a manner corresponding to the light module, the light multiple module may have a microprocessor that provides for an adjustment of the color locations of the individual light modules.

The light module described is suitable for illumination, in particular for indirect illumination. This advantageously enables energy-saving, comparatively ageing-stable general lighting. By means of the light module, a defined area can be chromatically homogeneously illuminated with homogeneous illuminance even when the light module is at a relatively small distance.

The light module can advantageously be used in a suitable manner for backlighting. In a manner corresponding to the light module, the light multiple module can be used for illumination, in particular for indirect illumination. Illumination applications on a large scale are conceivable with the light multiple module. By way of example the light multiple module is suitable for interior illumination of means of transport or company buildings. Furthermore, the light multiple module can be used for the backlighting of large screens.

The light module can, like the light multiple module, be used for illumination, in particular for indirect illumination of an aircraft interior.

In accordance with one preferred embodiment, the light module or the light multiple module is arranged in such a way that part of a wall or ceiling is illuminated. An indirect illumination of an interior is then effected by means of the illumination of the wall or ceiling.

### BRIEF DESCRIPTION OF THE DRAWINGS

FIG. 1 shows a schematic perspective view of a first exemplary embodiment of a light module according to the invention,

FIG. 2 shows a schematic cross-sectional view of a first exemplary embodiment of a light module according to the invention,

FIG. 3 shows a schematic plan view of a second exemplary embodiment of a light module according to the invention,

FIG. 4 shows a schematic cross-sectional view of an exemplary embodiment of a radiation-emitting semiconductor component that is suitable in the context of the invention,

FIG. 5 shows a schematic perspective view of a first light multiple module according to the invention,

FIG. 6 shows a schematic side view of part of an aircraft interior,

FIG. 7 shows a graph illustrating light distribution curves and color locations of a second exemplary embodiment of a light multiple module according to the invention.

### DETAILED DESCRIPTION OF THE DRAWINGS

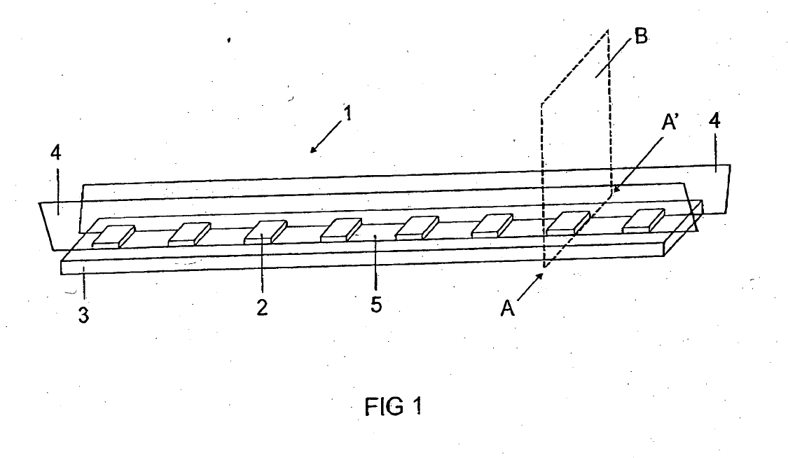

FIG. 1 illustrates a light module 1 having a plurality of radiation-emitting components 2. The components 2 are arranged on a carrier 3. The components 2 preferably form a row. They are applied at uniform distances on the carrier 3.

In the exemplary embodiment illustrated, the light module 1 has a total of eight components 2. However, the light module 1 is not restricted to this number of components. By way of example, the light module 1 may comprise twenty-four components 2, the carrier 3 having a thickness of approximately 1.5 mm.

The carrier 3, which is formed in particular from a metal core substrate, for instance a metal core circuit board, has a planar main area 5. The components 2 are arranged on the main area 5 of the carrier 3 along a longitudinal axis. Two opposite lateral areas of the components 2 respectively adjoin a side wall 4.

The side walls 4 extend along a longitudinal side of the carrier 3. They run obliquely with respect to the main area 5 of the carrier 3. By means of the side walls 4, whose surface facing the components 2 reflects the radiation generated by the components 2, the radiation can be focused and deflected in a suitable manner. The reflective effect of the side walls 4 may be brought about for example by a suitable mirror-coating thereof or an arrangement of a reflection hologram.

The side walls 4 together with the carrier 3 preferably form a type of well or channel. This has the advantage that a plurality of light modules can be connected to one another without any problems at the broad sides.

The side walls 4 and the carrier 3 may be separate parts. However, it is also conceivable for the side walls 4 to be formed integrally together with the carrier 3. By way of example, this may be effected in an injection-molding method on the basis of a plastic or ceramic material.

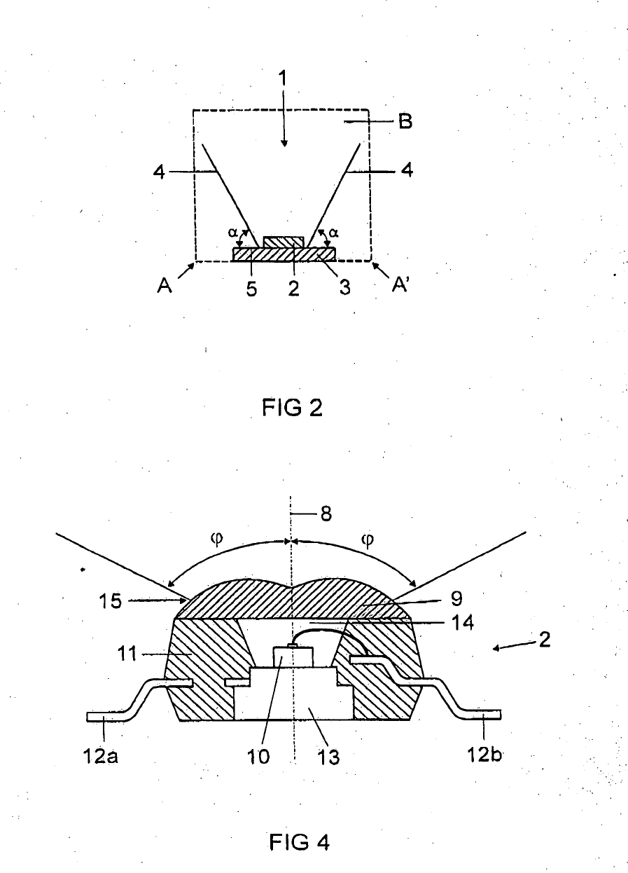

FIG. 2 reveals a sectional view of the light module 1 illustrated in FIG. 1 along the sectional plane B. The side walls 4 are inclined in such a way that they produce a V-form. The arrangement of the side walls may likewise correspond to a U-form.

The side walls 4 form an angle a of inclination with the main area 5 of the carrier 3. In the present exemplary embodiment, the angles of inclination of the two side walls do not differ from one another. However, it is also conceivable for the two angles of inclination to deviate from one another.

The angle α of inclination depends on the emission properties of the components 2 and a desired emission characteristic of the light module 1. The angle of inclination may be α=65°, for example. Such an angle α of inclination is suitable in particular when using the light module 1 for illumination purposes. In this case, the light module 1 advantageously comprises high-power components 2 having, for a suitable intermixing of the radiation generated, an optical element that enlarges the emission angle.

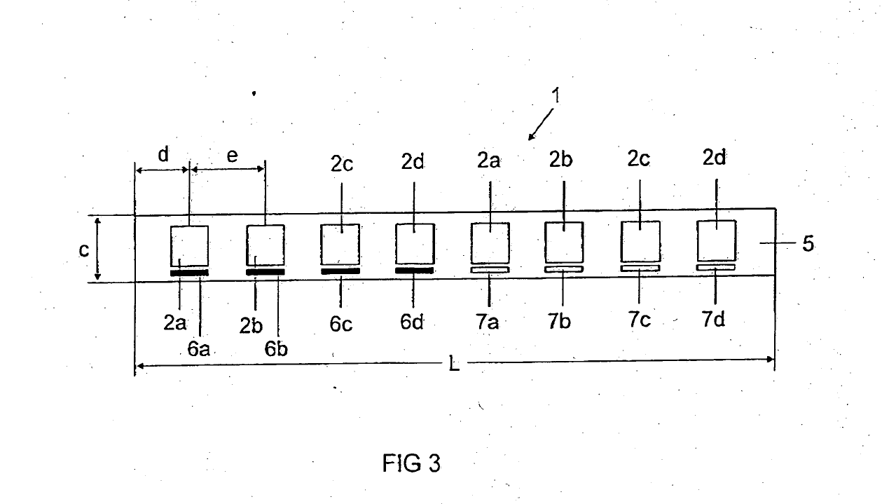

The light module 1 illustrated in a plan view in FIG. 3 has components 2a, 2b, 2c and 2d arranged in a row. The components differ by virtue of the color of the emitted radiation.

The components 2a emit red light, the components 2b emit green light, the components 2c emit blue light and the components 2d emit white light. Each component is arranged between two differently colored components. The components 2a, 2b, 2c and 2d are preferably high-power light-emitting diodes.

The components 2a, 2b and 2d supply in each case a luminous flux Φ=60 lm, for example, while the components 2c supply in each case a luminous flux Φ=20 lm.

In the present exemplary embodiment, the distance between the component 2a and the component 2b is e=12.5 mm. Moreover, the distance between a carrier edge and the component 2a is d=6.25 mm. If the components are spaced apart uniformly, the total length of the light module 1 is L=100 mm. The width of the light module 1 is c=30 mm.

The components of identical color are connected up in series. For the first components 2a, 2b, 2c and 2d, the electrical connections 6a, 6b, 6c and 6d serve as connections to the positive pole of a voltage source. For the second components 2a, 2b, 2c and 2d, the electrical connections 7a, 7b, 7c and 7d serve as connections to the negative pole of a voltage source.

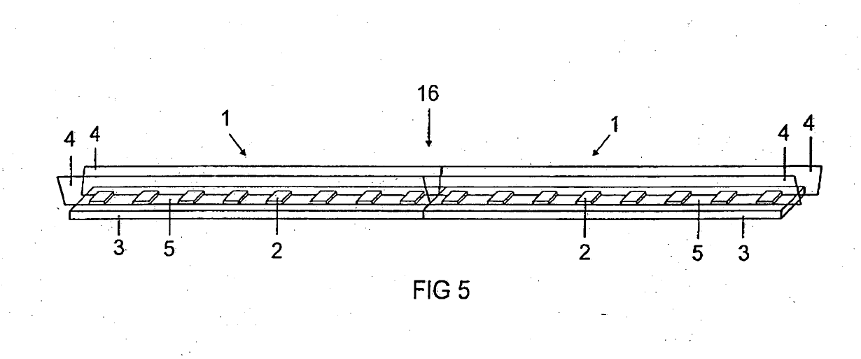

FIG. 4 illustrates a radiation-emitting semiconductor component 2 that is suitable in the context of the invention, said semiconductor component being surface-mountable. A component of this type is described in more detail for example in the above-mentioned US 2004/0075100.

The component 2 has an optical element 9. A radiation exit area 15 of the optical element 9 is preferably shaped in such a way that the radiation exit area 15 has a concavely curved partial region and a convexly curved partial region, which surrounds the concavely curved partial region at a distance from an optical axis 8, wherein the optical axis 8 runs through the concavely curved partial region.

The radiation exit area 15 of the optical element 9 has a wing-like shape in cross section.

By means of the optical element 9, the component 2 can have an emission angle 2φ=120°, where the illuminance at the angle φ=60° is 50% of the maximum illuminance of the component 2 which is obtained in the direction of the optical axis 8.

Without the optical element 9 having a radiation exit area 15 as described, the emission angle 2φ of the component 2 would be smaller, which would entail disadvantages for the intermixing of the radiation.

The radiation-emitting component 2 has a housing body 11 having a recess 14. A radiation-emitting semiconductor body 10 is arranged in the recess 14, which semiconductor body may be encapsulated by means of a potting compound.

A leadframe having the connection strips 12a and 12b, by means of which the semiconductor body 10 can be electrically connected, is embedded into the housing body 11.

The semiconductor body 10 is arranged on a heat connection part 13, which, during operation, provides for a comparatively good heat dissipation and hence for a stable functioning of the component 2.

FIG. 5 illustrates a light multiple module 16 having two light modules 1. The light modules 1 are strung together in the longitudinal direction and thus form a type of light string. As an alternative, the light modules 1 can be connected to one another in matrix-like fashion, with the result that they have an areal arrangement.

The light modules 1 are constructed for example like the light module 1 illustrated in FIG. 1 or FIG. 3.

The light multiple module 16 may be used for example in an LED large screen. Furthermore, it is suitable for a light box that can be utilized for example for the backlighting of a screen.

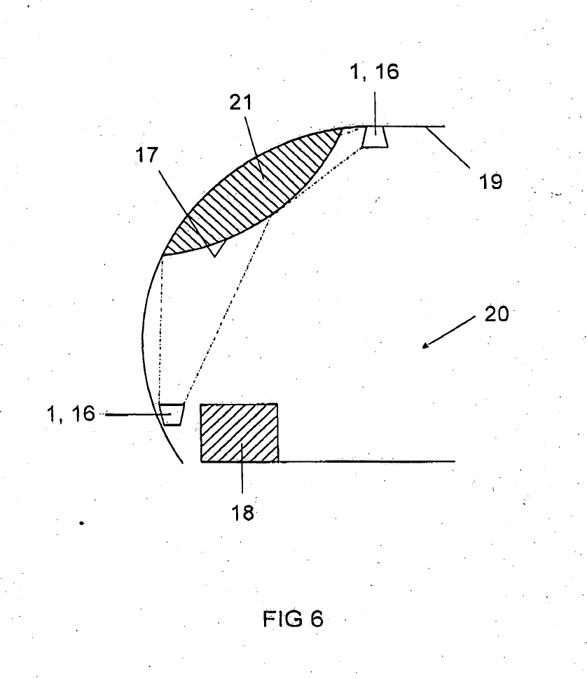

A further use of a light module or light multiple module becomes apparent in FIG. 6. Part 20 of an aircraft interior equipped with a row 18 of seats and a luggage flap 21 can be seen. Arranged at the level of the row 18 of seats is a light module 1 or a light multiple module 16, which illuminates a wall 17 of the luggage flap. The aircraft interior is thereby illuminated indirectly.

A further light module 1 or light multiple module 16 is arranged at a ceiling 19, and illuminates the wall 17.

It is conceivable furthermore to fit to the wall 17 an additional light module or light multiple module (not illustrated) which illuminates a row of seats opposite the row 18 of seats.

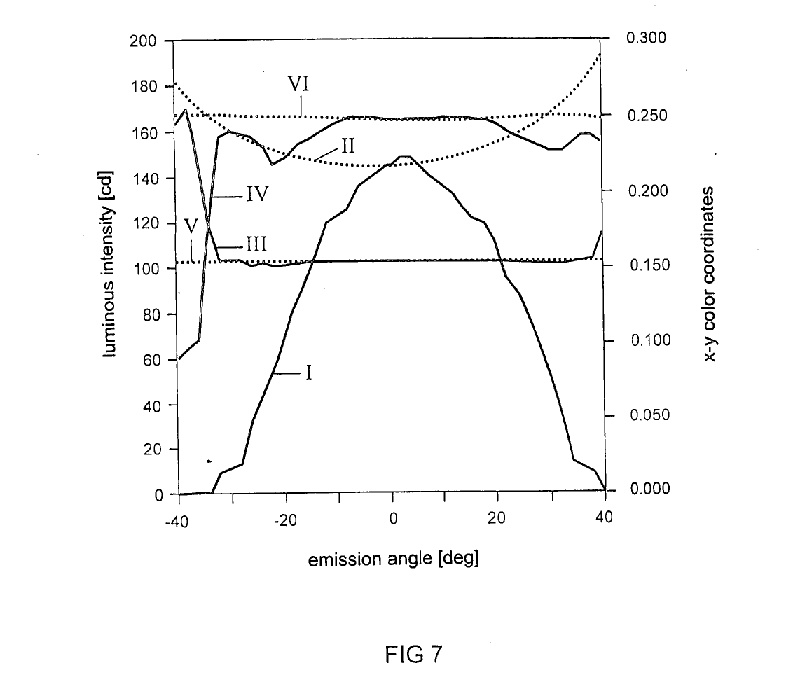

The curves designated by I and II in FIG. 7 are light distribution curves of a light multiple module composed of six light modules strung together. The light modules in each case have a semiconductor component emitting blue and green light.

The components are arranged in pairs on a carrier preferably containing aluminum. A length of 300 mm results overall for the light multiple module. Side walls with a preferred angle of inclination of α=65° are fitted to the carrier main area.

The measurement data illustrated are results of measurements that were carried out by means of a detector at a measurement distance of 4 m.

The light distribution curve I indicates values for the luminous intensity in a horizontal direction running perpendicular to the longitudinal direction of the light multiple module. The light distribution curve II indicates values for the luminous intensity in a vertical direction running parallel to the longitudinal direction of the light multiple module.

It can be seen that the luminous intensity of the light module in a horizontal direction falls toward larger emission angles, in contrast to the vertical direction. At emission angles of −19.4° and 26.7°, the value has fallen to 50% of the maximum value. A relatively homogeneous area illumination can be effected within this angular range.

The curves III and IV illustrate distributions for the x-y color coordinates in a horizontal direction. The curves V and VI illustrate distributions for the x-y color coordinates in a vertical direction. As can be seen, the color locations in the horizontal and vertical direction correspond to one another, to be precise in an emission angle range of between −10° and 10°, as a result of which a chromatically homogeneous area illumination can advantageously be effected in this angular range.

The invention is not restricted by the description on the basis of the exemplary embodiments. Rather, the invention encompasses any new feature and also any combination of features, which in particular comprises any combination of features in the patent claims, even if this feature or this combination itself is not explicitly specified in the patent claims or exemplary embodiments. Furthermore, the invention is not restricted to an illuminant setting, but rather encompasses any desired color location setting.

We claim:

1. A light module comprising:
a plurality of radiation-emitting semiconductor components, each of which is assigned an emission angle, wherein at least one of the components has an optical element that enlarges the emission angle; and
a common optical device for focusing the radiation,
wherein the radiation is intermixed by means of the optical element.

2. The light module as claimed in claim 1, wherein the radiation is intermixed in such a way that a uniform color location is assigned to a predetermined area illuminated by means of the light module.

3. The light module as claimed in claim 2, wherein the radiation is focused by means of the optical device in such a way that the predetermined area is illuminated by means of the light module with a uniform luminous intensity.

4. The light module as claimed in claim 1, wherein each component has an optical element for enlarging the emission angle.

5. The light module as claimed in claim 1, wherein the optical element has a radiation exit area comprising a concavely curved partial region and a convexly curved partial region, which at least partly surrounds the concavely curved partial region at a distance from an optical axis, wherein the optical axis runs through the concavely curved partial region.

6. The light module as claimed in claim 1, wherein the components are arranged on a carrier.

7. The light module as claimed in claim 1, wherein the optical device is a reflective element.

8. The light module as claimed in claim 6, wherein the optical device is a reflective element, and the optical device is formed by means of reflective side walls connected to the carrier.

9. The light module as claimed in claim 8, wherein the side walls form an angle of inclination of 0°<α≦90° with a main area (5) of the carrier.

10. The light module as claimed in claim 9, wherein the angle of inclination is α=65°.

11. The light module as claimed in claim 1, wherein the optical device is a refractive or diffractive element.

12. The light module as claimed in claim 6, wherein an arrangement comprising the carrier and the optical device has a well form or channel form.

13. The light module as claimed in claim 1, wherein at least two components generate radiation of different colors.

14. The light module as claimed in claim 13, wherein a first component generates red light, a second component generates green light, a third component generates blue light and a fourth component generates white light.

15. The light module as claimed in claim 13, wherein the light module is assigned different color locations by means of a change in the current supply of the components.

16. The light module as claimed in claim 1, wherein at least two components generate radiation of the same color.

17. The light module as claimed in claim 16, wherein the components that generate radiation of the same color are connected up in series.

18. The light module as claimed in claim 1, wherein the components are arranged in row-like fashion.

19. The light module as claimed in claim 1, wherein the components are surface-mountable.

20. The light module as claimed in claim 1, wherein each component has a housing body in which a radiation-emitting semiconductor body is arranged.

21. A light multiple module, which has at least two light modules as claimed in claim 1.

22. The light multiple module as claimed in claim 21, wherein the light modules are arranged in row-like fashion.

23. The light multiple module as claimed in claim 21, wherein the light modules are arranged in matrix-like fashion.

24. The light multiple module as claimed in claim 21, wherein the light modules are connected up in parallel.

25. The light multiple module as claimed in claim 21, wherein a predetermined area illuminated by means of the light modules is assigned in each case the same color location.
